(19) United States
(12) Patent Application Publication
(10) Pub. No.: US 2026/0030710 A1
(43) Pub. Date: Jan. 29, 2026

(54) RADIX SORT OPTIMIZATION BASED ON UPFRONT OFFSET CALCULATIONS

(71) Applicant: QUALCOMM Incorporated, San Diego, CA (US)

(72) Inventors: Alexander Lauson ANGUS, La Jolla, CA (US); Shangqing GU, San Diego, CA (US); Hongqiang WANG, San Diego, CA (US)

(21) Appl. No.: 18/784,255

(22) Filed: Jul. 25, 2024

(51) Int. Cl. G06T 1/20

(52) U.S. Cl. CPC G06T 1/20

(57) ABSTRACT

This disclosure provides systems, devices, apparatus, and methods, including computer programs encoded on storage media, for radix sort optimization based on upfront offset calculations. A graphics processor may compute a plurality of histograms by counting radix digits of a set of data. The graphics processor may determine a plurality of global offsets over the computed plurality of histograms. The graphics processor may determine a plurality of local offsets based on the plurality of global offsets or refrain from determining the plurality of local offsets based on the plurality of global offsets. The graphics processor may sort the set of data based on the plurality of global offsets and the plurality of local offsets. The graphics processor may output an indicator of the sorted set of data.

### TECHNICAL FIELD

The present disclosure relates generally to processing systems and, more particularly, to one or more techniques for graphics processing.

### INTRODUCTION

Computing devices often perform graphics and/or display processing (e.g., utilizing a graphics processing unit (GPU), a central processing unit (CPU), a display processor, etc.) to render and display visual content. Such computing devices may include, for example, computer workstations, mobile phones such as smartphones, embedded systems, personal computers, tablet computers, and video game consoles. GPUs are configured to execute a graphics processing pipeline that includes one or more processing stages, which operate together to execute graphics processing commands and output a frame. A central processing unit (CPU) may control the operation of the GPU by issuing one or more graphics processing commands to the GPU. Modern day CPUs are typically capable of executing multiple applications concurrently, each of which may need to utilize the GPU during execution. A display processor is configured to convert digital information received from a CPU to analog values and may issue commands to a display panel for displaying the visual content. A device that provides content for visual presentation on a display may utilize a GPU and/or a display processor.

Current techniques may not address radix sort inefficiencies. There is a need for improved radix sort optimization techniques.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus a memory; and at least one processor coupled to the memory and, based at least in part on information stored in the memory, the at least one processor may be configured to compute a plurality of histograms by counting radix digits of a set of data. The at least one processor may be configured to determine a plurality of global offsets over the computed plurality of histograms. The at least one processor may be configured to determine a plurality of local offsets based on the determined plurality of global offsets or refrain from determining the plurality of local offsets based on the determined plurality of global offsets. The at least one processor may be configured to sort the set of data based on the determined plurality of global offsets and the determined plurality of local offsets. The at least one processor may be configured to output an indicator of the sorted set of data.

In some aspects, the techniques described herein relate to a method of graphics processing, including: computing a plurality of histograms by counting radix digits of a set of data; determining a plurality of global offsets over the computed plurality of histograms; determining a plurality of local offsets based on the determined plurality of global offsets or refraining from determining the plurality of local offsets based on the determined plurality of global offsets; sorting the set of data based on the determined plurality of global offsets and the determined plurality of local offsets; and outputting an indicator of the sorted set of data.

In some aspects, the techniques described herein relate to a method, where computing the plurality of histograms by counting radix digits of the set of data and determining the plurality of global offsets over the computed plurality of histograms includes: executing a kernel based on the set of data to compute the plurality of histograms and determine the plurality of global offsets.

In some aspects, the techniques described herein relate to a method, where determining the plurality of local offsets based on the determined plurality of global offsets or refraining from determining the plurality of local offsets based on the determined plurality of global offsets includes: performing a reduction over the determined plurality of global offsets; and refraining from determining the plurality of local offsets in response to the performed reduction indicating a uniformity.

In some aspects, the techniques described herein relate to a method, where performing the reduction over the determined plurality of global offsets includes: performing a global offset scan to determine a prefix scan over the computed plurality of histograms; and reducing the prefix scan based on a uniformity index, where the reduced prefix scan indicates the uniformity.

In some aspects, the techniques described herein relate to a method, where determining the plurality of local offsets based on the determined plurality of global offsets or refraining from determining the plurality of local offsets based on the determined plurality of global offsets includes: performing a reduction over the determined plurality of global offsets; and executing a plurality of kernels to determine the plurality of local offsets in response to the performed reduction indicating a non-uniformity.

In some aspects, the techniques described herein relate to a method, performing the reduction over the determined plurality of global offsets includes: performing a global offset scan to determine a prefix scan over the computed plurality of histograms; and reducing the prefix scan based on a uniformity index, where the reduced prefix scan indicates the non-uniformity.

In some aspects, the techniques described herein relate to a method, where computing the plurality of histograms by counting radix digits of the set of data includes: splitting the set of data into a plurality of bit segments having a threshold number of bits; and counting the threshold number of bits of the radix digits of the set of data for each pass of the plurality of bit segments.

In some aspects, the techniques described herein relate to a method, where outputting the indicator of the sorted set of data includes at least one of: storing the indicator of the sorted set of data; or transmitting the indicator of the sorted set of data.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram that illustrates an example content generation system, in accordance with one or more techniques of this disclosure.

FIG. 2 illustrates an example GPU, in accordance with one or more techniques of this disclosure.

FIG. 3 is a diagram illustrating example processing components, in accordance with one or more techniques of this disclosure.

FIG. 4 illustrates exemplary radix sort techniques, in accordance with one or more techniques of this disclosure.

FIG. 5 is a call flow diagram illustrating example communications between a CPU and a GPU in accordance with one or more techniques of this disclosure.

FIG. 6 is a flowchart of an example method of graphics processing.

### DETAILED DESCRIPTION

Various aspects of systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of this disclosure to those skilled in the art. Based on the teachings herein one skilled in the art should appreciate that the scope of this disclosure is intended to cover any aspect of the systems, apparatuses, computer program products, and methods disclosed herein, whether implemented independently of, or combined with, other aspects of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. Any aspect disclosed herein may be embodied by one or more elements of a claim.

Although various aspects are described herein, many variations and permutations of these aspects fall within the scope of this disclosure. Although some potential benefits and advantages of aspects of this disclosure are mentioned, the scope of this disclosure is not intended to be limited to particular benefits, uses, or objectives. Rather, aspects of this disclosure are intended to be broadly applicable to different wireless technologies, system configurations, processing systems, networks, and transmission protocols, some of which are illustrated by way of example in the figures and in the following description. The detailed description and drawings are merely illustrative of this disclosure rather than limiting, the scope of this disclosure being defined by the appended claims and equivalents thereof.

Several aspects are presented with reference to various apparatus and methods. These apparatus and methods are described in the following detailed description and illustrated in the accompanying drawings by various blocks, components, circuits, processes, algorithms, and the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors (which may also be referred to as processing units). Examples of processors include microprocessors, microcontrollers, graphics processing units (GPUs), general purpose GPUs (GPGPUs), central processing units (CPUs), application processors, digital signal processors (DSPs), reduced instruction set computing (RISC) processors, systems-on-chip (SOCs), baseband processors, application specific integrated circuits (ASICs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software can be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

The term application may refer to software. As described herein, one or more techniques may refer to an application (e.g., software) being configured to perform one or more functions. In such examples, the application may be stored in a memory (e.g., on-chip memory of a processor, system memory, or any other memory). Hardware described herein, such as a processor may be configured to execute the application. For example, the application may be described as including code that, when executed by the hardware, causes the hardware to perform one or more techniques described herein. As an example, the hardware may access the code from a memory and execute the code accessed from the memory to perform one or more techniques described herein. In some examples, components are identified in this disclosure. In such examples, the components may be hardware, software, or a combination thereof. The components may be separate components or sub-components of a single component.

In one or more examples described herein, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can include a random access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

As used herein, instances of the term “content” may refer to “graphical content,” an “image,” etc., regardless of whether the terms are used as an adjective, noun, or other parts of speech. In some examples, the term “graphical content,” as used herein, may refer to a content produced by one or more processes of a graphics processing pipeline. In further examples, the term “graphical content,” as used herein, may refer to a content produced by a processing unit configured to perform graphics processing. In still further examples, as used herein, the term “graphical content” may refer to a content produced by a graphics processing unit.

The following description is directed to examples for the purposes of describing innovative aspects of this disclosure. However, a person having ordinary skill in the art may recognize that the teachings herein may be applied in a multitude of ways. Some or all of the described examples may be implemented in any device or system that is capable of processing graphics commands. Various aspects relate generally to reprojecting and/or composing frames for a graphics processing unit (GPU). Some aspects more specifically relate to applying reprojection fallback strategies during an excess system load (e.g., when a reprojection process for a frame will not complete in time to display the frame). For example, a graphics system may have limited dynamic random access memory (DRAM) bandwidth due to concurrent work (e.g., rendering, GPU workload, high-intensity periods of camera data acquisition), software control latencies (e.g., poorly optimized code, latencies when communicating with third-party applications), bottlenecking hardware execution, and/or power/thermal throttling. Such loads may affect the calculated projected time for a reprojection process to complete within a threshold period of time. Use of remotely-rendered framebuffers (e.g., frames processed by a reprojection topology on a separate system, or a third-party system), may also affect the time to render a frame. For example, use of a second reprojection process may conserve resources if a first reprojection process uses remote-rendered framebuffers having a high calculated latency value, or if a first reprojection process uses a large amount of bandwidth (e.g., WiFi, 5G bandwidth) and a system is configured to conserve use of that bandwidth with respect to transmission/reception of remote-rendered frames.

In some examples, a graphics processor (or graphics processor system) may compute a plurality of histograms by counting radix digits of a set of data. For example, to sort a set of d-bit elements, the graphics processor may consider k bits at a time. For every k bits, the graphics processor may compute each histogram by counting radix-k digits, or bits. In other words, the calculation may be a computation of a global histogram based on the count of the radix-k digits/bits. The graphics processor may calculate a plurality of global offsets over the computed plurality of histograms. For example, the graphics processor may calculate a prefix scan over each of the plurality of histograms. The graphics processor may calculate a plurality of local offsets based on the calculated plurality of global offsets or refrain from calculating the plurality of local offsets based on the calculated plurality of global offsets. For example, the calculated plurality of global offsets may be uniform (e.g., each of the radix-k digits/bits may be the same). The graphics processor may check for uniformity by performing a reduction over the global offset scan. Where the plurality of global offsets is uniform, the graphics processor may repeat the processor for the next k bits of the set of d-bit elements. The graphics processor may sort the set of data based on the calculated plurality of global offsets and the calculated plurality of local offsets. For example, the graphics processor may compute the local offset and write elements to a sorted order once the graphics processor stops, or refrains from continuing to calculate the plurality of local offsets. The graphics processor may output an indicator of the sorted set of data.

Such techniques may be used to optimize a radix sort. For example, in each radix sort pass, a radix optimizer may consider k bits of the input. If all k bits are identical for each input element, the radix optimizer may skip the pass for that bit-window. Once the radix optimizer confirms that all bits in the k bits being considered are uniform, the radix optimizer may terminate the pass without impacting the correctness of the final sort. The radix optimizer may determine the uniformity after the digit count step (e.g., a histogram of counts for each digit, or bit combination). If all counts fall in the same histogram bin, then the radix optimizer may determine the bit-windows to be uniform for all inputs, and the radix optimizer may apply an early stopping mechanism. Subsequent calculations of a global offset scan and a reorder may not be performed where the radix optimizer determines uniformity. The power and time savings of this early stopping mechanism may be proportional to the number of passes that are terminated early. In some aspects, the radix optimizer may check for uniformity in all bit-windows upfront. For example, in a first aspect, a digit count may always precede a global offset scan and a reorder for a given pass. In a second aspect, a radix optimizer may compute a digit count for all passes upfront, and combine the digit count with a global offset scan to complete the uniformity check earlier in the program.

Particular aspects of the subject matter described in this disclosure can be implemented to realize one or more of the following potential advantages. In some examples, by prematurely stopping the iterations of digit counting based on an upfront global offset calculation, the described techniques can be used to avoid wasteful compute power and data movement on radix sort procedures.

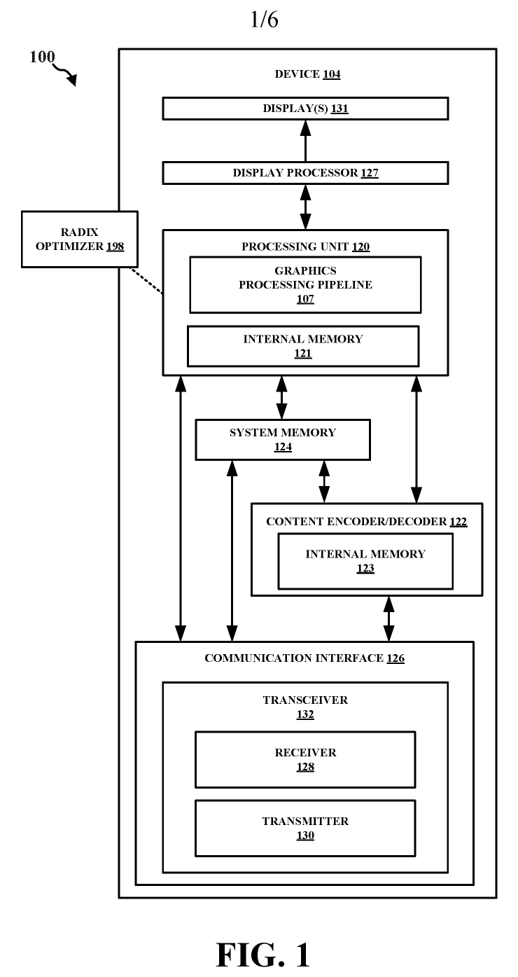

FIG. 1 is a block diagram that illustrates an example content generation system 100 configured to implement one or more techniques of this disclosure. The content generation system 100 includes a device 104. The device 104 may include one or more components or circuits for performing various functions described herein. In some examples, one or more components of the device 104 may be components of an SOC. The device 104 may include one or more components configured to perform one or more techniques of this disclosure. In the example shown, the device 104 may include a processing unit 120, a content encoder/decoder 122, and a system memory 124. In some aspects, the device 104 may include a number of components, e.g., a communication interface 126, a transceiver 132, a receiver 128, a transmitter 130, a display processor 127, and one or more displays 131. Reference to the display 131 may refer to the one or more displays 131. For example, the display 131 may include a single display or multiple displays. The display 131 may include a first display and a second display. The first display may be a left-eye display and the second display may be a right-eye display. In some examples, the first and second display may receive different frames for presentment thereon. In other examples, the first and second display may receive the same frames for presentment thereon. In further examples, the results of the graphics processing may not be displayed on the device, e.g., the first and second display may not receive any frames for presentment thereon. Instead, the frames or graphics processing results may be transferred to another device. In some aspects, this may be referred to as split-rendering.

The processing unit 120 may include an internal memory 121. The processing unit 120 may be configured to perform graphics processing, such as in a graphics processing pipeline 107. The content encoder/decoder 122 may include an internal memory 123. In some examples, the device 104 may include a display processor, such as the display processor 127, to perform one or more display processing techniques on one or more frames generated by the processing unit 120 before presentment by the one or more displays 131. The display processor 127 may be configured to perform display processing. For example, the display processor 127 may be configured to perform one or more display processing techniques on one or more frames generated by the processing unit 120. The one or more displays 131 may be configured to display or otherwise present frames processed by the display processor 127. In some examples, the one or more displays 131 may include one or more of: a liquid crystal display (LCD), a plasma display, an organic light emitting diode (OLED) display, a projection display device, an augmented reality display device, a virtual reality display device, a head-mounted display, or any other type of display device.

Memory external to the processing unit 120 and the content encoder/decoder 122, such as system memory 124, may be accessible to the processing unit 120 and the content encoder/decoder 122. For example, the processing unit 120 and the content encoder/decoder 122 may be configured to read from and/or write to external memory, such as the system memory 124. The processing unit 120 and the content encoder/decoder 122 may be communicatively coupled to the system memory 124 over a bus. In some examples, the processing unit 120 and the content encoder/decoder 122 may be communicatively coupled to each other over the bus or a different connection.

The content encoder/decoder 122 may be configured to receive graphical content from any source, such as the system memory 124 and/or the communication interface 126. The system memory 124 may be configured to store received encoded or decoded graphical content. The content encoder/decoder 122 may be configured to receive encoded or decoded graphical content, e.g., from the system memory 124 and/or the communication interface 126, in the form of encoded pixel data. The content encoder/decoder 122 may be configured to encode or decode any graphical content.

The internal memory 121 or the system memory 124 may include one or more volatile or non-volatile memories or storage devices. In some examples, internal memory 121 or the system memory 124 may include RAM, SRAM, DRAM, erasable programmable ROM (EPROM), electrically erasable programmable ROM (EEPROM), flash memory, a magnetic data media or an optical storage media, or any other type of memory.

The internal memory 121 or the system memory 124 may be a non-transitory storage medium according to some examples. The term “non-transitory” may indicate that the storage medium is not embodied in a carrier wave or a propagated signal. However, the term “non-transitory” should not be interpreted to mean that internal memory 121 or the system memory 124 is non-movable or that its contents are static. As one example, the system memory 124 may be removed from the device 104 and moved to another device. As another example, the system memory 124 may not be removable from the device 104.

The processing unit 120 may be a central processing unit (CPU), a graphics processing unit (GPU), a general purpose GPU (GPGPU), or any other processing unit that may be configured to perform graphics processing. In some examples, the processing unit 120 may be integrated into a motherboard of the device 104. In some examples, the processing unit 120 may be present on a graphics card that is installed in a port in a motherboard of the device 104, or may be otherwise incorporated within a peripheral device configured to interoperate with the device 104. The processing unit 120 may include one or more processors, such as one or more microprocessors, GPUs, application specific integrated circuits (ASICs), field programmable gate arrays (FPGAs), arithmetic logic units (ALUs), digital signal processors (DSPs), discrete logic, software, hardware, firmware, other equivalent integrated or discrete logic circuitry, or any combinations thereof. If the techniques are implemented partially in software, the processing unit 120 may store instructions for the software in a suitable, non-transitory computer-readable storage medium, e.g., internal memory 121, and may execute the instructions in hardware using one or more processors to perform the techniques of this disclosure. Any of the foregoing, including hardware, software, a combination of hardware and software, etc., may be considered to be one or more processors.

The content encoder/decoder 122 may be any processing unit configured to perform content decoding. In some examples, the content encoder/decoder 122 may be integrated into a motherboard of the device 104. The content encoder/decoder 122 may include one or more processors, such as one or more microprocessors, application specific integrated circuits (ASICs), field programmable gate arrays (FPGAs), arithmetic logic units (ALUs), digital signal processors (DSPs), video processors, discrete logic, software, hardware, firmware, other equivalent integrated or discrete logic circuitry, or any combinations thereof. If the techniques are implemented partially in software, the content encoder/decoder 122 may store instructions for the software in a suitable, non-transitory computer-readable storage medium, e.g., internal memory 123, and may execute the instructions in hardware using one or more processors to perform the techniques of this disclosure. Any of the foregoing, including hardware, software, a combination of hardware and software, etc., may be considered to be one or more processors.

In some aspects, the content generation system 100 may include a communication interface 126. The communication interface 126 may include a receiver 128 and a transmitter 130. The receiver 128 may be configured to perform any receiving function described herein with respect to the device 104. Additionally, the receiver 128 may be configured to receive information, e.g., eye or head position information, rendering commands, or location information, from another device. The transmitter 130 may be configured to perform any transmitting function described herein with respect to the device 104. For example, the transmitter 130 may be configured to transmit information to another device, which may include a request for content. The receiver 128 and the transmitter 130 may be combined into a transceiver 132. In such examples, the transceiver 132 may be configured to perform any receiving function and/or transmitting function described herein with respect to the device 104.

Referring again to FIG. 1, in certain aspects, the processing unit 120 may include a radix optimizer 198 configured to compute a plurality of histograms by counting radix digits of a set of data. The radix optimizer 198 may also be configured to calculate a plurality of global offsets over the computed plurality of histograms. The radix optimizer 198 may also be configured to calculate a plurality of local offsets based on the calculated plurality of global offsets or refrain from calculating the plurality of local offsets based on the calculated plurality of global offsets. The radix optimizer 198 may also be configured to sort the set of data based on the calculated plurality of global offsets and the calculated plurality of local offsets. The radix optimizer 198 may also be configured to output an indicator of the sorted set of data.

Although the following description may be focused on display processing, the concepts described herein may be applicable to other similar processing techniques.

As described herein, a device, such as the device 104, may refer to any device, apparatus, or system configured to perform one or more techniques described herein. For example, a device may be a server, a base station, user equipment, a client device, a station, an access point, a computer, e.g., a personal computer, a desktop computer, a laptop computer, a tablet computer, a computer workstation, or a mainframe computer, an end product, an apparatus, a phone, a smart phone, a server, a video game platform or console, a handheld device, e.g., a portable video game device or a personal digital assistant (PDA), a wearable computing device, e.g., a smart watch, an augmented reality device, or a virtual reality device, a non-wearable device, a display or display device, a television, a television set-top box, an intermediate network device, a digital media player, a video streaming device, a content streaming device, an in-car computer, any mobile device, any device configured to generate graphical content, or any device configured to perform one or more techniques described herein. Processes herein may be described as performed by a particular component (e.g., a GPU), but, in further embodiments, may be performed using other components (e.g., a CPU), consistent with disclosed embodiments.

GPUs may process multiple types of data or data packets in a GPU pipeline. For instance, in some aspects, a GPU may process two types of data or data packets, e.g., context register packets and draw call data. A context register packet may be a set of global state information, e.g., information regarding a global register, shading program, or constant data, which may regulate how a graphics context will be processed. For example, context register packets may include information regarding a color format. In some aspects of context register packets, there may be a bit that indicates which workload belongs to a context register. Also, there may be multiple functions or programming running at the same time and/or in parallel. For example, functions or programming may describe a certain operation, e.g., the color mode or color format. Accordingly, a context register may define multiple states of a GPU.

Context states may be utilized to determine how an individual processing unit functions, e.g., a vertex fetcher (VFD), a vertex shader (VS), a shader processor, or a geometry processor, and/or in what mode the processing unit functions. In order to do so, GPUs may use context registers and programming data. In some aspects, a GPU may generate a workload, e.g., a vertex or pixel workload, in the pipeline based on the context register definition of a mode or state. Certain processing units, e.g., a VFD, may use these states to determine certain functions, e.g., how a vertex is assembled. As these modes or states may change, GPUs may need to change the corresponding context. Additionally, the workload that corresponds to the mode or state may follow the changing mode or state.

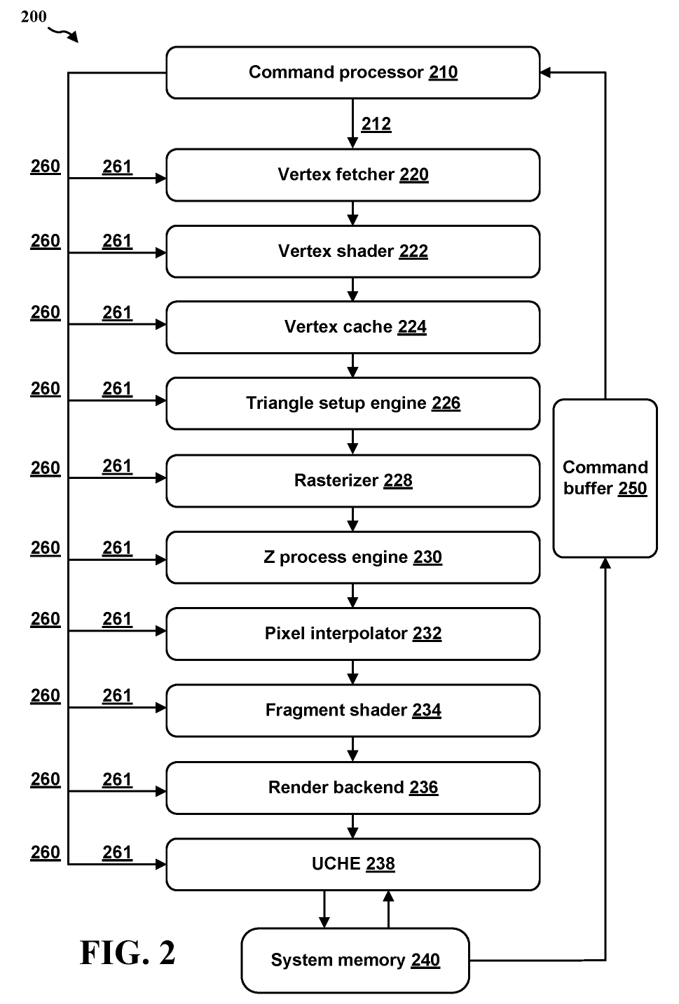

FIG. 2 illustrates an example GPU 200 in accordance with one or more techniques of this disclosure. As shown in FIG. 2, GPU 200 includes command processor (CP) 210, draw call packets 212, VFD 220, VS 222, vertex cache (VPC) 224, triangle setup engine (TSE) 226, rasterizer (RAS) 228, Z process engine (ZPE) 230, pixel interpolator (PI) 232, fragment shader (FS) 234, render backend (RB) 236, level 1 (L1) cache (cluster cache (CCHE)) 237, level 2 (L2) cache (UCHE) 238, and system memory 240. Although FIG. 2 displays that GPU 200 includes processing units 220-238, GPU 200 may include a number of additional processing units. Additionally, processing units 220-238 are merely an example and any combination or order of processing units may be used by GPUs according to the present disclosure. GPU 200 also includes command buffer 250, context register packets 260, and context states 261.

As shown in FIG. 2, a GPU may utilize a CP, e.g., CP 210, or hardware accelerator to parse a command buffer into context register packets, e.g., context register packets 260, and/or draw call data packets, e.g., draw call packets 212. The CP 210 may then send the context register packets 260 or draw call packets 212 through separate paths to the processing units or blocks in the GPU. Further, the command buffer 250 may alternate different states of context registers and draw calls. For example, a command buffer may be structured in the following manner: context register of context N, draw call(s) of context N, context register of context N+1, and draw call(s) of context N+1.

GPUs may render images in a variety of different ways. In some instances, GPUs may render an image using rendering and/or tiled rendering. In tiled rendering GPUs, an image may be divided or separated into different sections or tiles. After the division of the image, each section or tile may be rendered separately. Tiled rendering GPUs may divide computer graphics images into a grid format, such that each portion of the grid, i.e., a tile, is separately rendered. In some aspects, during a binning pass, an image may be divided into different bins or tiles. In some aspects, during the binning pass, a visibility stream may be constructed where visible primitives or draw calls may be identified. In contrast to tiled rendering, direct rendering does not divide the frame into smaller bins or tiles. Rather, in direct rendering, the entire frame is rendered at a single time. Additionally, some types of GPUs may allow for both tiled rendering and direct rendering.

Instructions executed by a CPU (e.g., software instructions) or a display processor may cause the CPU or the display processor to search for and/or generate a composition strategy for composing a frame based on a dynamic priority and runtime statistics associated with one or more composition strategy groups. A frame to be displayed by a physical display device, such as a display panel, may include a plurality of layers. Also, composition of the frame may be based on combining the plurality of layers into the frame (e.g., based on a frame buffer). After the plurality of layers are combined into the frame, the frame may be provided to the display panel for display thereon. The process of combining each of the plurality of layers into the frame may be referred to as composition, frame composition, a composition procedure, a composition process, or the like.

A frame composition procedure or composition strategy may correspond to a technique for composing different layers of the plurality of layers into a single frame. The plurality of layers may be stored in doubled data rate (DDR) memory. Each layer of the plurality of layers may further correspond to a separate buffer. A composer or hardware composer (HWC) associated with a block or function may determine an input of each layer/buffer and perform the frame composition procedure to generate an output indicative of a composed frame. That is, the input may be the layers and the output may be a frame composition procedure for composing the frame to be displayed on the display panel.

Some types of GPUs may include different types of pipelines, such as a graphics processing pipeline. Graphics processing pipelines may include one or more of a vertex shader stage, a hull shader stage, a domain shader stage, a geometry shader stage, and a pixel shader stage. These stages of the graphics processing pipeline may be considered shader stages. These shader stages may be implemented as one or more shader programs that execute on shader units at a GPU. Shader units may be configured as a programmable pipeline of processing components. In some examples, a shader unit may be referred to as “shader processors” or “unified shaders,” and may perform geometry, vertex, pixel, or other shading operations to render graphics. Shader units may include shader processors, each of which may include one or more components for fetching and decoding operations, one or more arithmetic logic units (ALUs) for carrying out arithmetic calculations, one or more memories, caches, and registers.

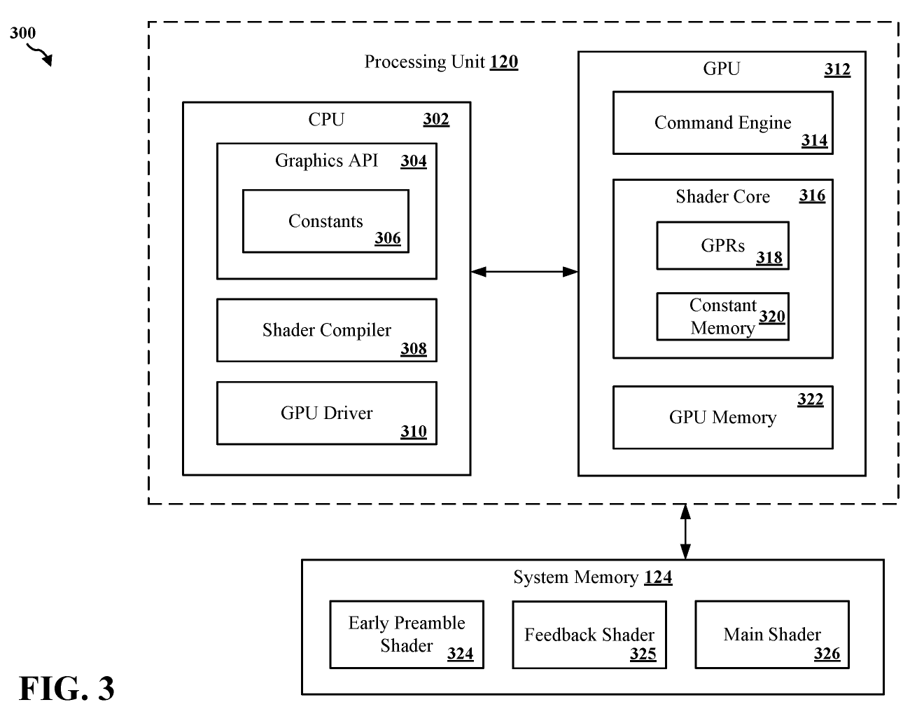

FIG. 3 is a diagram 300 that illustrates processing components, such as the processing unit 120 and the system memory 124, as may be identified in connection with the device 104 for processing data. In aspects, the processing unit 120 may include a CPU 302 and a GPU 312. The GPU 312 and the CPU 302 may be formed as an integrated circuit (e.g., a system-on-a-chip (SOC)) and/or the GPU 312 may be incorporated onto a motherboard with the CPU 302. Alternatively, the CPU 302 and the GPU 312 may be configured as distinct processing units that are communicatively coupled to each other. For example, the GPU 312 may be incorporated on a graphics card that is installed in a port of the motherboard that includes the CPU 302.

The CPU 302 may be configured to execute a software application that causes graphical content to be displayed (e.g., on the display(s) 131 of the device 104) based on one or more operations of the GPU 312. The software application may issue instructions to a graphics application program interface (API) 304, which may be a runtime program that translates instructions received from the software application into a format that is readable by a GPU driver 310. After receiving instructions from the software application via the graphics API 304, the GPU driver 310 may control an operation of the GPU 312 based on the instructions. For example, the GPU driver 310 may generate one or more command streams that are placed into the system memory 124, where the GPU 312 is instructed to execute the command streams (e.g., via one or more system calls). A command engine 314 included in the GPU 312 is configured to retrieve the one or more commands stored in the command streams. The command engine 314 may provide commands from the command stream for execution by the GPU 312. The command engine 314 may be hardware of the GPU 312, software/firmware executing on the GPU 312, or a combination thereof. While the GPU driver 310 is configured to implement the graphics API 304, the GPU driver 310 is not limited to being configured in accordance with any particular API. The system memory 124 may store the code for the GPU driver 310, which the CPU 302 may retrieve for execution. In examples, the GPU driver 310 may be configured to allow communication between the CPU 302 and the GPU 312, such as when the CPU 302 offloads graphics or non-graphics processing tasks to the GPU 312 via the GPU driver 310.

The system memory 124 may further store source code for one or more of an early preamble shader 324, a feedback shader 325, or a main shader 326. In such configurations, a shader compiler 308 executing on the CPU 302 may compile the source code of the shaders 324-326 to create object code or intermediate code executable by a shader core 316 of the GPU 312 during runtime (e.g., at the time when the shaders 324-326 are to be executed on the shader core 316). In some examples, the shader compiler 308 may pre-compile the shaders 324-326 and store the object code or intermediate code of the shader programs in the system memory 124. The shader compiler 308 (or in another example the GPU driver 310) executing on the CPU 302 may build a shader program with multiple components including the early preamble shader 324, the feedback shader 325, and the main shader 326. The main shader 326 may correspond to a portion or the entirety of the shader program that does not include the early preamble shader 324 or the feedback shader 325. The shader compiler 308 may receive instructions to compile the shader(s) 324-326 from a program executing on the CPU 302. The shader compiler 308 may also identify constant load instructions and common operations in the shader program for including the common operations within the early preamble shader 324 (rather than the main shader 326). The shader compiler 308 may identify such common instructions, for example, based on (presently undetermined) constants 306 to be included in the common instructions. The constants 306 may be defined within the graphics API 304 to be constant across an entire draw call. The shader compiler 308 may utilize instructions such as a preamble shader start to indicate a beginning of the early preamble shader 324 and a preamble shader end to indicate an end of the early preamble shader 324. Similar instructions may be used for the feedback shader 325 and the main shader 326. The feedback shader 325 will be described in further detail below.

The shader core 316 included in the GPU 312 may include general purpose registers (GPRs) 318 and constant memory 320. The GPRs 318 may correspond to a single GPR, a GPR file, and/or a GPR bank. Each GPR in the GPRs 318 may store data accessible to a single thread. The software and/or firmware executing on GPU 312 may be a shader program 324-326, which may execute on the shader core 316 of GPU 312. The shader core 316 may be configured to execute many instances of the same instructions of the same shader program in parallel. For example, the shader core 316 may execute the main shader 326 for each pixel that defines a given shape. The shader core 316 may transmit and receive data from applications executing on the CPU 302. In examples, constants 306 used for execution of the shaders 324-326 may be stored in a constant memory 320 (e.g., a read/write constant RAM) or the GPRs 318. The shader core 316 may load the constants 306 into the constant memory 320. In further examples, execution of the early preamble shader 324 or the feedback shader 325 may cause a constant value or a set of constant values to be stored in on-chip memory such as the constant memory 320 (e.g., constant RAM), the GPU memory 322, or the system memory 124. The constant memory 320 may include memory accessible by all aspects of the shader core 316 rather than just a particular portion reserved for a particular thread such as values held in the GPRs 318.

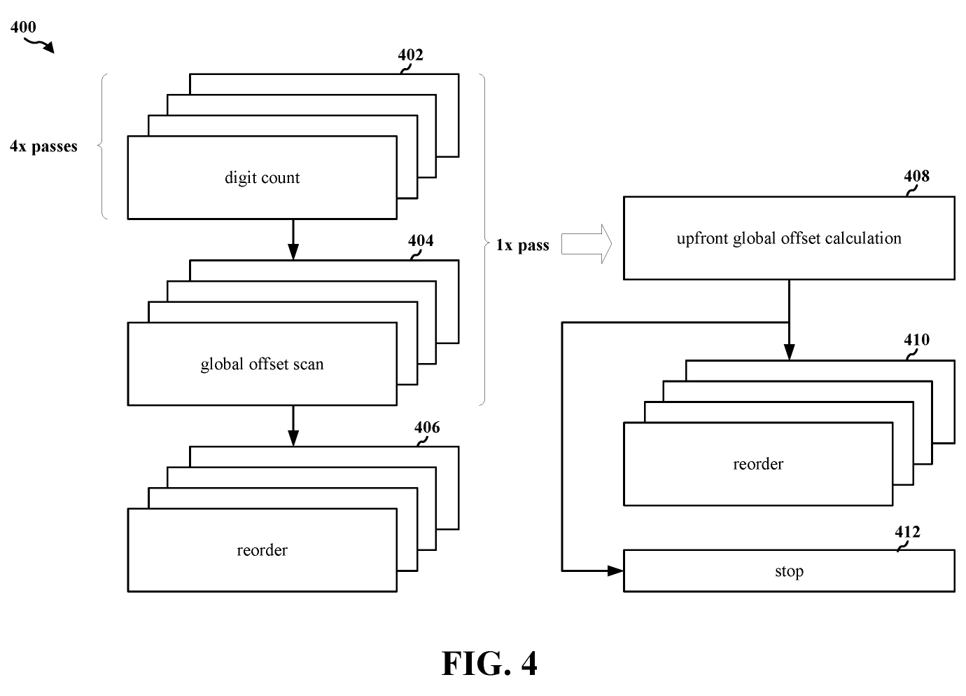

FIG. 4 is a diagram 400 that illustrates a first radix sort technique having a set of digit counts 402, a set of global offset scans 404, and a set of reordering procedures 406 side-by-side with a second radix sort technique having an upfront global offset calculation 408 which may result in either a set of reordering procedures 410 or a stop procedure 412.

A GPU may perform radix sorting on a set of unsorted elements. In one aspect, the GPU may perform radix sorting for GPU ray tracing acceleration. For example, by building a bounding volume hierarchy (BVH) using radix sorting. In one aspect, the GPU may perform radix sorting for virtual reality applications. For example, by generating realistic facial avatars using radix sorting, or by performing Gaussian splatting GPU rendering using radix sorting. In one aspect, the GPU may perform radix sorting for automotive functions. For example, by calculating autonomous driving algorithms on a GPU using radix sorting.

The first radix sort technique having the set of digit counts 402, the set of global offset scans 404, and the set of reordering procedures 406 may be used to sort a set of d-bit elements. For each element of d bits, a radix optimizer may consider k bits at a time. The radix optimizer may repeat each digit count of the set of digit counts 402, each global offset scan of the set of global offset scans 404, and each reordering procedure of the set of reordering procedures 406 for d / k passes. For example, for a 32-bit type of element, the radix optimizer may consider 8 bits at a time, performing four passes to sort all elements of d bits. While the diagram 400 illustrates four passes, a radix optimizer may perform any number of d / k passes to sort a number of elements of d bits.

The set of digit counts 402 may include a computation of a global histogram by counting radix-k digits of a set of elements. The set of global offset scans 404 may include a calculation of a prefix scan over the computed histogram. The set of reordering procedures 406 may include a scatter, where the radix optimizer may compute the local offset and write elements to a sorted order. The first radix sort technique may repeat this process for d / k passes to sort the elements of d bits. Each of the set of digit counts 402, the set of global offset scans 404, and the set of reordering procedures 406 may be performed using a separate GPU kernel. For example, the first radix sort technique shown in diagram 400 may use 12 kernel launches. However, if the radix-k digits are uniform, the pass may not result in any meaningful sorting, as uniform digits will not affect a sort order.

In the second radix sort technique, the upfront global offset calculation 408 may be a single kernel that performs an upfront global offset calculation. The kernel may compute the global histogram by counting radix-k digits and calculate a prefix scan over a histogram. Then, for each of the calculated prefix scan, the radix optimizer may check for uniformity by performing a reduction over the global offset scan. If the radix-k digits are uniform, the radix optimizer may skip the reordering procedure for that set of uniform radix-k digits and proceed to the stop procedure 412 for that set of radix-k digits. If the radix-k digits are not uniform, the radix optimizer may perform the reordering procedure for that set of non-uniform radix-k digits and proceed to perform the corresponding set of reordering procedures 410 for that set of radix-k digits.

The upfront global offset calculation 408 may combine the set of digit counts 402 and the set of global offset scans 404 into a single kernel. This reduces the number of kernel launches by d / k * 3 – 1. The upfront global offset calculation 408 may also allow the uniformity check to occur earlier in the process. The power and time savings may be proportion to the number of kernel launches eliminated and/or the number of reorder passes that are terminated early via the stop procedure 412.

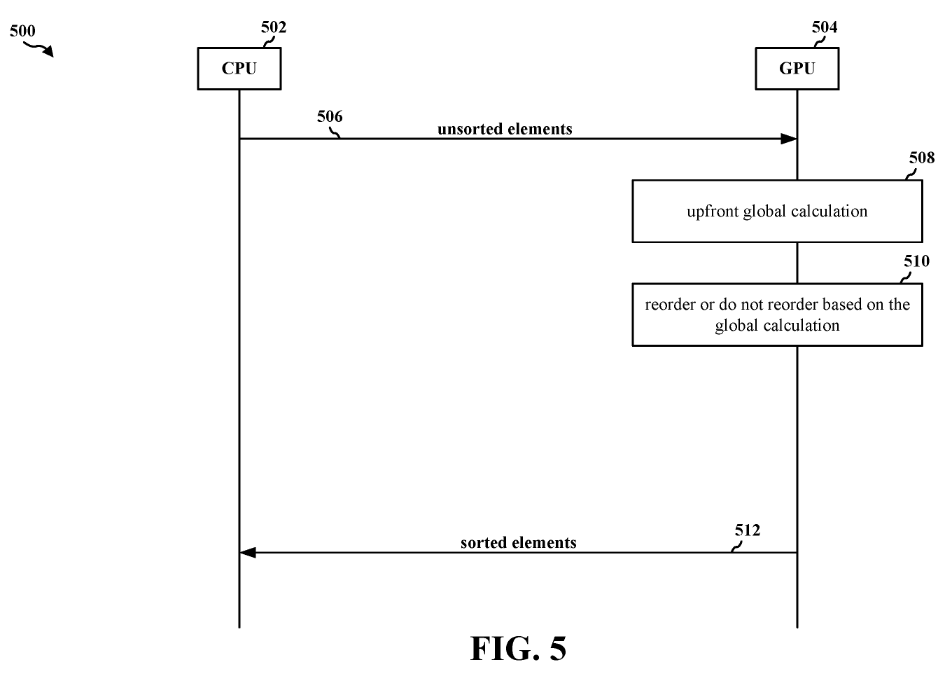

FIG. 5 is a call flow diagram 500 illustrating example communications between a CPU 502 and a GPU 504. The CPU 502 may transmit an indication of a set of unsorted elements 506 to the GPU 504. The GPU 504 may receive the indication of a set of unsorted elements 506 from the CPU 502. At 508, the GPU 504 may perform an upfront global calculation for the set of unsorted elements 506. At 510, the GPU 504 may determine whether or not to reorder each set of radix-k digits based on whether the global calculation of the set of radix-k digits are uniform. The GPU 504 may then transmit the indication of the sorted element 512 to the CPU 502.

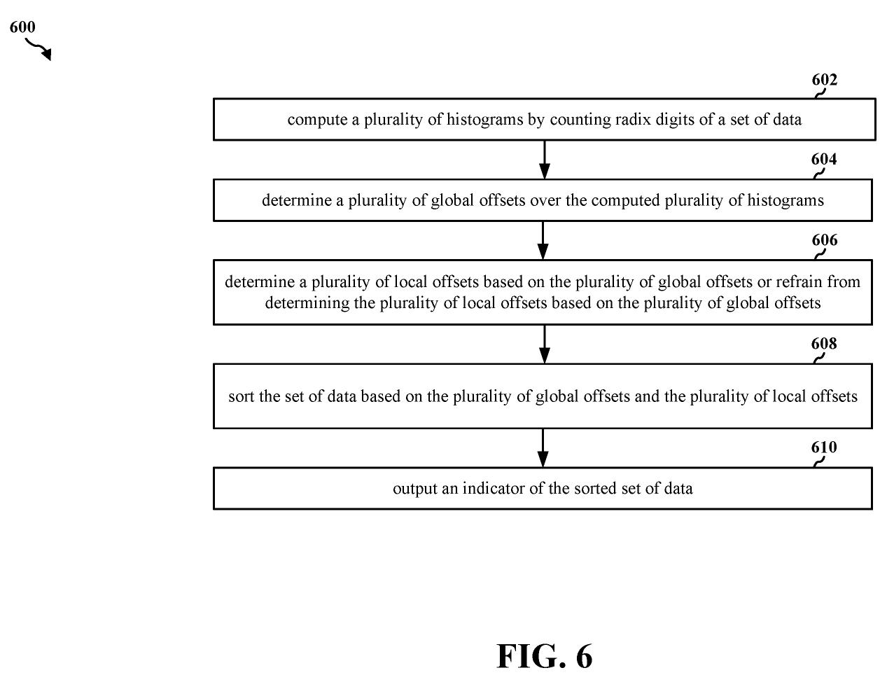

FIG. 6 is a flowchart 600 of an example method of graphics processing in accordance with one or more techniques of this disclosure. The method may be performed by an apparatus, such as an apparatus for graphics processing, a GPU, a CPU a wireless communication device, and the like, as used in connection with the aspects of FIGS. 1-5.

At 602, the apparatus may compute a plurality of histograms by counting radix digits of a set of data. For example, 602 may be performed by the GPU 504 in FIG. 5, which may compute a plurality of histograms by counting radix digits of a set of data. Moreover, 602 may be performed by the radix optimizer 198 in FIG. 1.

At 604, the apparatus may determine a plurality of global offsets over the computed plurality of histograms. For example, 604 may be performed by the GPU 504 in FIG. 5, which may determine a plurality of global offsets over the computed plurality of histograms. Moreover, 604 may be performed by the radix optimizer 198 in FIG. 1.

At 606, the apparatus may determine a plurality of local offsets based on the determined plurality of global offsets or refrain from determining the plurality of local offsets based on the determined plurality of global offsets. For example, 606 may be performed by the GPU 504 in FIG. 5, which may determine a plurality of local offsets based on the determined plurality of global offsets or refrain from determining the plurality of local offsets based on the determined plurality of global offsets. Moreover, 606 may be performed by the radix optimizer 198 in FIG. 1.

At 608, the apparatus may sort the set of data based on the determined plurality of global offsets and the determined plurality of local offsets. For example, 608 may be performed by the GPU 504 in FIG. 5, which may sort the set of data based on the determined plurality of global offsets and the determined plurality of local offsets. Moreover, 608 may be performed by the radix optimizer 198 in FIG. 1.

At 610, the apparatus may output an indicator of the sorted set of data. For example, 610 may be performed by the GPU 504 in FIG. 5, which may output an indicator of the sorted set of data. Moreover, 610 may be performed by the radix optimizer 198 in FIG. 1.

In configurations, a method or an apparatus for graphics processing is provided. The apparatus may be a GPU, a CPU, or some other processor that may perform graphics processing. In aspects, the apparatus may be the processing unit 120 within the device 104, or may be some other hardware within the device 104 or another device. The apparatus may include means for computing a plurality of histograms by counting radix digits of a set of data. The apparatus may further include means for determining a plurality of global offsets over the computed plurality of histograms. The apparatus may further include means for determining a plurality of local offsets based on the determined plurality of global offsets or refraining from determining the plurality of local offsets based on the determined plurality of global offsets. The apparatus may further include means for sorting the set of data based on the determined plurality of global offsets and the determined plurality of local offsets. The apparatus may further include means for outputting an indicator of the sorted set of data.

The subject matter described herein may be implemented to realize one or more benefits or advantages. For instance, the described graphics processing techniques may be used by a cache, a GPU, a CPU, a central processor, or some other processor that may perform graphics processing to implement the higher radix fast Fourier transform (FFT) techniques described herein. This may also be accomplished at a low cost compared to other graphics processing techniques. Moreover, the graphics processing techniques herein may improve or speed up graphics processing or execution. Further, the graphics processing techniques herein may improve resource or data utilization and/or resource efficiency. Additionally, aspects of the present disclosure may utilize higher radix FFT techniques in order to improve memory bandwidth efficiency and/or increase processing speed at a cache, a CPU, a GPU, or a display processing unit (DPU).

It is understood that the specific order or hierarchy of blocks in the processes / flowcharts disclosed is an illustration of example approaches. Based upon design preferences, it is understood that the specific order or hierarchy of blocks in the processes / flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects.

Unless specifically stated otherwise, the term “some” refers to one or more and the term “or” may be interpreted as “and/or” where context does not dictate otherwise. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium.

In accordance with this disclosure, the term “or” may be interpreted as “and/or” where context does not dictate otherwise. Additionally, while phrases such as “one or more” or “at least one” or the like may have been used for some features disclosed herein but not others, the features for which such language was not used may be interpreted to have such a meaning implied where context does not dictate otherwise.

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium. Computer-readable media may include computer data storage media or communication media including any medium that facilitates transfer of a computer program from one place to another. In this manner, computer-readable media generally may correspond to (1) tangible computer-readable storage media, which is non-transitory or (2) a communication medium such as a signal or carrier wave. Data storage media may be any available media that may be accessed by one or more computers or one or more processors to retrieve instructions, code and/or data structures for implementation of the techniques described in this disclosure. By way of example, and not limitation, such computer-readable media may comprise RAM, ROM, EEPROM, CD-ROM or other optical disk storage, magnetic disk storage or other magnetic storage devices. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media. A computer program product may include a computer-readable medium.

The code may be executed by one or more processors, such as one or more digital signal processors (DSPs), general purpose microprocessors, application specific integrated circuits (ASICs), arithmetic logic units (ALUs), field programmable logic arrays (FPGAs), or other equivalent integrated or discrete logic circuitry. Accordingly, the term “processor,” as used herein may refer to any of the foregoing structure or any other structure suitable for implementation of the techniques described herein. Also, the techniques could be fully implemented in one or more circuits or logic elements.

The techniques of this disclosure may be implemented in a wide variety of devices or apparatuses, including a wireless handset, an integrated circuit (IC) or a set of ICs, e.g., a chip set. Various components, modules or units are described in this disclosure to emphasize functional aspects of devices configured to perform the disclosed techniques, but do not necessarily need realization by different hardware units. Rather, as described above, various units may be combined in any hardware unit or provided by a collection of inter-operative hardware units, including one or more processors as described above, in conjunction with suitable software and/or firmware. Accordingly, the term “processor,” as used herein may refer to any of the foregoing structure or any other structure suitable for implementation of the techniques described herein. Also, the techniques may be fully implemented in one or more circuits or logic elements.

The following aspects are illustrative only and may be combined with other aspects or teachings described herein, without limitation.

Aspect 1 is a method of graphics processing, comprising: computing a plurality of histograms by counting radix digits of a set of data; determining a plurality of global offsets over the computed plurality of histograms; determining a plurality of local offsets based on the plurality of global offsets or refraining from determining the plurality of local offsets based on the plurality of global offsets; sorting the set of data based on the plurality of global offsets and the plurality of local offsets; and outputting an indicator of the sorted set of data.

Aspect 2 is the method of aspect 1, wherein computing the plurality of histograms by counting radix digits of the set of data and determining the plurality of global offsets over the computed plurality of histograms comprises: executing a kernel based on the set of data to compute the plurality of histograms and determining the plurality of global offsets.

Aspect 3 is the method of either of aspects 1 or 2, wherein determining the plurality of local offsets based on the plurality of global offsets or refraining from determining the plurality of local offsets based on the plurality of global offsets comprises: performing a reduction over the plurality of global offsets; and refraining from determining the plurality of local offsets in response to the performed reduction indicating a uniformity.

Aspect 4 is the method of aspect 3, wherein performing the reduction over the plurality of global offsets comprises: performing a global offset scan to determine a prefix scan over the computed plurality of histograms; and reducing the prefix scan based on a uniformity index, wherein the reduced prefix scan indicates the uniformity.

Aspect 5 is the method of any of aspects 1 to 4, wherein determining the plurality of local offsets based on the plurality of global offsets or refraining from determining the plurality of local offsets based on the plurality of global offsets comprises: performing a reduction over the plurality of global offsets; and executing a plurality of kernels to determine the plurality of local offsets in response to the performed reduction indicating a non-uniformity.

Aspect 6 is the method of aspect 5, wherein performing the reduction over the plurality of global offsets comprises: performing a global offset scan to determine a prefix scan over the computed plurality of histograms; and reducing the prefix scan based on a uniformity index, wherein the reduced prefix scan indicates the non-uniformity.

Aspect 7 is the method of any of aspects 1 to 6, wherein computing the plurality of histograms by counting radix digits of the set of data comprises: splitting the set of data into a plurality of bit segments having a threshold number of bits; and counting the threshold number of bits of the radix digits of the set of data for each pass of the plurality of bit segments.

Aspect 8 is the method of any of aspects 1 to 7, wherein outputting the indicator of the sorted set of data comprises at least one of: storing the indicator of the sorted set of data; or transmitting the indicator of the sorted set of data.

Aspect 9 is the method of any of aspects 1 to 8, wherein determining the plurality of global offsets over the computed plurality of histograms and determining the plurality of local offsets or refraining from determining the plurality of local offsets comprises: calculating the plurality of global offsets over the computed plurality of histograms; and calculating the plurality of local offsets or refrain from calculating the plurality of local offsets.

Aspect 10 is an apparatus for graphics processing including at least one processor coupled to a memory and configured to implement a method as in any of aspects 1-9.

Aspect 11 may be combined with aspect 10 and includes that the apparatus is a wireless communication device.

Aspect 12 is an apparatus for graphics processing including means for implementing a method as in any of aspects 1-9.

Aspect 13 is a computer-readable medium (e.g., a non-transitory computer-readable medium) storing computer executable code, the code when executed by at least one processor causes the at least one processor to implement a method as in any of aspects 1-9.

Various aspects have been described herein. These and other aspects are within the scope of the following claims.

What is claimed is:

1. An apparatus for graphics processing, comprising:
a memory; and
a processor coupled to the memory and, based at least in part on information stored in the memory, the processor is configured to:
compute a plurality of histograms by counting radix digits of a set of data;
determine a plurality of global offsets over the computed plurality of histograms;
determine a plurality of local offsets based on the plurality of global offsets or refrain from determining the plurality of local offsets based on the plurality of global offsets;
sort the set of data based on the plurality of global offsets and the plurality of local offsets; and
output an indicator of the sorted set of data.

2. The apparatus of claim 1, wherein, to compute the plurality of histograms by counting the radix digits of the set of data and to determine the plurality of global offsets over the computed plurality of histograms, the processor is configured to:
execute a kernel based on the set of data to compute the plurality of histograms and determine the plurality of global offsets.

3. The apparatus of claim 1, wherein, to determine the plurality of local offsets based on the plurality of global offsets or to refrain from determining the plurality of local offsets based on the plurality of global offsets, the processor is configured to:
perform a reduction over the plurality of global offsets; and refrain from determining the plurality of local offsets in response to the performed reduction indicating a uniformity.

4. The apparatus of claim 3, wherein to perform the reduction over the plurality of global offsets, the processor is configured to:
perform a global offset scan to determine a prefix scan over the computed plurality of histograms; and reduce the prefix scan based on a uniformity index, wherein the reduced prefix scan indicates the uniformity.

5. The apparatus of claim 1, wherein, to determine the plurality of local offsets based on the plurality of global offsets or to refrain from determining the plurality of local offsets based on the plurality of global offsets, the processor is configured to:
perform a reduction over the plurality of global offsets; and execute a plurality of kernels to determine the plurality of local offsets in response to the performed reduction indicating a non-uniformity.

6. The apparatus of claim 5, wherein to perform the reduction over the plurality of global offsets, the processor is configured to:
perform a global offset scan to determine a prefix scan over the computed plurality of histograms; and reduce the prefix scan based on a uniformity index, wherein the reduced prefix scan indicates the non-uniformity.

7. The apparatus of claim 1, wherein, to compute the plurality of histograms by counting the radix digits of the set of data, the processor is configured to:
split the set of data into a plurality of bit segments having a threshold number of bits; and count the threshold number of bits of the radix digits of the set of data for each pass of the plurality of bit segments.

8. The apparatus of claim 1, wherein, to output the indicator of the sorted set of data, the processor is configured to at least one of:
store the indicator of the sorted set of data; or transmit the indicator of the sorted set of data.

9. The apparatus of claim 1, wherein, to determine the plurality of global offsets over the computed plurality of histograms and to determine the plurality of local offsets or refrain from determining the plurality of local offsets, the processor is configured to:
calculate the plurality of global offsets over the computed plurality of histograms; and
calculate the plurality of local offsets or refrain from calculating the plurality of local offsets.

10. A method of graphics processing, comprising:
computing a plurality of histograms by counting radix digits of a set of data; determining a plurality of global offsets over the computed plurality of histograms;
determining a plurality of local offsets based on the plurality of global offsets or refraining from determining the plurality of local offsets based on the plurality of global offsets; sorting the set of data based on the plurality of global offsets and the plurality of local offsets; and outputting an indicator of the sorted set of data.

11. The method of claim 10, wherein computing the plurality of histograms by counting the radix digits of the set of data and determining the plurality of global offsets over the computed plurality of histograms comprises:
executing a kernel based on the set of data to compute the plurality of histograms and determine the plurality of global offsets.

12. The method of claim 10, wherein determining the plurality of local offsets based on the plurality of global offsets or refraining from determining the plurality of local offsets based on the plurality of global offsets comprises:
performing a reduction over the plurality of global offsets; and
refraining from determining the plurality of local offsets in response to the performed reduction indicating a uniformity.

13. The method of claim 12, wherein performing the reduction over the plurality of global offsets comprises:
performing a global offset scan to determine a prefix scan over the computed plurality of histograms; and
reducing the prefix scan based on a uniformity index, wherein the reduced prefix scan indicates the uniformity.

14. The method of claim 10, wherein determining the plurality of local offsets based on the plurality of global offsets or refraining from determining the plurality of local offsets based on the plurality of global offsets comprises:
performing a reduction over the plurality of global offsets; and
executing a plurality of kernels to determine the plurality of local offsets in response to the performed reduction indicating a non-uniformity.

15. The method of claim 14, wherein performing the reduction over the plurality of global offsets comprises:
performing a global offset scan to determine a prefix scan over the computed plurality of histograms; and
reducing the prefix scan based on a uniformity index, wherein the reduced prefix scan indicates the non-uniformity.

16. The method of claim 10, wherein computing the plurality of histograms by counting the radix digits of the set of data comprises:
splitting the set of data into a plurality of bit segments having a threshold number of bits; and
counting the threshold number of bits of the radix digits of the set of data for each pass of the plurality of bit segments.

17. The method of claim 10, wherein outputting the indicator of the sorted set of data comprises at least one of:
storing the indicator of the sorted set of data; or transmitting the indicator of the sorted set of data.

18. The method of claim 10, wherein determining the plurality of global offsets over the computed plurality of histograms and determining the plurality of local offsets or refrain from determining the plurality of local offsets comprises:
calculating the plurality of global offsets over the computed plurality of histograms; and
calculating the plurality of local offsets or refrain from calculating the plurality of local offsets.

19. A computer-readable medium storing computer executable code, the code when executed by a processor, causes the processor to:
compute a plurality of histograms by counting radix digits of a set of data;
determine a plurality of global offsets over the computed plurality of histograms;
determine a plurality of local offsets based on the plurality of global offsets or refrain from determining the plurality of local offsets based on the plurality of global offsets;
sort the set of data based on the plurality of global offsets and the plurality of local offsets; and
output an indicator of the sorted set of data.

20. The computer-readable medium of claim 19, wherein, to compute the plurality of histograms by counting the radix digits of the set of data and to determine the plurality of global offsets over the computed plurality of histograms, the code, when executed by the processor, causes the processor to:
execute a kernel based on the set of data to compute the plurality of histograms and determine the plurality of global offsets.
